(19) United States
(12) Patent Application Publication
(10) Pub. No.: US 2007/0291494 A1
(43) Pub. Date: Dec. 20, 2007

(54) LED REFLECTOR ASSEMBLY FOR IMPROVING THE COLOR RENDERING INDEX OF THE LIGHT OUTPUT

(76) Inventor: Robert D. Galli, North Kingstown, RI (US)

Correspondence Address: BARLOW, JOSEPHS & HOLMES, LTD., 101 DYER STREET, 5TH FLOOR, PROVIDENCE, RI, 02903, US

(21) Appl. No.: 11/762,533

(22) Filed: Jun. 13, 2007

Related U.S. Application Data
(60) Provisional application No. 60/805,228, filed on Jun. 20, 2006.

(51) Int. Cl. F21V 7/00

(52) U.S. Cl. 362/341

(57) ABSTRACT

A lighting assembly is provided that includes a white LED and a reflector assembly, wherein the surface of the reflector assembly selectively reflects a portion of the output from the LED in a manner that results in a color temperature shift of the light output from the LED. To produce the color shift in the light output, the reflective surface of the reflector assembly is coated with a thin film of material. The coating causes a shift in the composite light output from the LED in combination with the reflector that moves towards a lower color temperature or a warmer hue. In turn, the shift produces a composite light output that exhibits a greatly improved color rendering index, while also maintaining a high level of efficiency for the assembly as a whole.

### CROSS-REFERENCE TO RELATED APPLICATIONS

This application is related to and claims priority from earlier filed U.S. Provisional Patent Application No. 60/805,228, filed Jun. 20, 2006.

### BACKGROUND OF THE INVENTION

The present invention relates generally to a new assembly for altering the color rendering index and/or color temperature of the light output from a white light emitting diode (LED). More specifically, the present invention relates to a reflector assembly for use in connection with a white LED to selectively adjust the color temperature of the LED light output to produce a warm white light, thereby improving relative color-rendering index (CRI) of the light.

In the lighting industry, LEDs are becoming far more common and widely used. LEDs are used as signal lights, indicating devices, warning lamps and flashlights. They offer many advantages relative to other light-emitting components, such as incandescent lamps, because they have a long service life, a great resistance to shocks and vibrations, high packing densities, require a low operating voltage and have a low power consumption.

Generally, however, LED's produce visible light in a narrow wavelength band that corresponds to only a single one of the various colors in the visible light spectrum. While this is suitable for use in connection with colored signal lights or as indicating devices, such limited spectrum light is undesirable for use in the typical visible ambient lighting application. In one attempt to produce an LED more suitable for ambient white light output, LEDs having a short wave output, i.e. blue and ultraviolet light, have been combined with a suitable phosphor. In this type of LED, the phosphor coating converts the short-wave light into the desired color by absorbing the short-wave light and re-radiating a longer wavelength light of a different color that corresponds to the type of phosphor. In this manner, white light can be generated, for example, by a blue-emitting LED if the LED is combined with a phosphor that absorbs blue light, converts it and subsequently emits it as light in the yellow-orange range of the spectrum. In this example, the yellow-orange light mixes with the remaining blue light from the LED and the combination of blue and the complementary color yellow results in white light.

It is well known in the art that while LEDs manufactured using a blue emitter die and a yellow-orange phosphor emit white light, the light output still tends to have a relatively high color temperature. The higher color temperature translates into a white light that has a bluish cast that in turn creates an environmental light that has a poor color rendering index, thereby making the light undesirable for certain applications. As a result, the poor color rendering index has prevented any substantial expansion of the use of LEDs for commercial and residential applications.

In order to further improve the color rendering index, prior art devices have either resorted to adjusting the mixture of phosphors that are applied over the LED die or the use of colored filters in front of the LEDs. While adjusting the phosphor mix has had some success, the color-rendering index has not been improved to the point that such lights meet the demands required for the desired architectural uses. Additionally, such changes in the phosphor mix also result in a drop in the output efficiency of the LED. Similarly, while filters can improve the relative color-rendering index of the light output, the trade-off associated with the use of a filter is that the light output is diminished making the assembly less efficient.

Therefore, there is a need for an LED lighting assembly that provides a high color rendering index. There is a further need for an LED lighting assembly that can be tailored to produce a controlled shift in the color of the white light output produced by an LED that results in a relatively high color rendering index while also maintaining a high efficiency as compared to LEDs of the prior art.

### BRIEF SUMMARY OF THE INVENTION

In this regard, the present invention provides a novel lighting assembly that includes, in combination, a white LED and a reflector assembly wherein the surface of the reflector assembly selectively reflects a portion of the output from the LED in a manner that results in a color temperature shift of the light output from the LED. The shift may be used to lower the color temperature of the light output thereby improving the color rendering index of the light. To produce the color shift in the light output, the highly reflective surface of the reflector assembly is coated with a thin film of material. In a preferred embodiment the thin film of material has a hue that imparts a gold or amber tone to the light reflected therefrom. More preferably, the thin film coating is formed from gold that is deposited onto the reflector surface using any technique well known in the art for the formation of such a film. The thickness of the thin film may be varied to provide a coating density that creates a reflective effect of between 10% to 100%. The reasoning for selecting gold is that the material itself is reflective and would thereby impart a color shift in the light output while absorbing a portion of the light output that falls in the blue visible light range thereby balancing the color output from the LED and shifting the output into a lower color temperature range.

In this manner the coating causes a shift in the composite light output from the LED in combination with the reflector that moves towards a lower color temperature or a warmer hue. In turn, the shift produces a composite light output that exhibits a greatly improved color rendering index. The result is that the present invention produces a spectral shift in a portion of the light output that is reflected by the reflector, in turn causing that portion of the light output to move towards longer wavelength warmer tones of light, while also maintaining a high level of efficiency for the assembly as a whole.

Therefore, it is an object of the present invention to provide an LED lighting assembly that produces a light output having a high color rendering index. It is a further object of the present invention to provide an LED lighting assembly that can be tailored to produce a controlled shift in the color of the white light output produced by an LED that results in a relatively high color rendering index while also maintaining a high efficiency as compared to LEDs of the prior art.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a graph showing the spectral distribution of the output from a prior art white light emitting diode;

FIG. 2 is a graph depicting the spectral distribution of the reflectivity of a gold reflector surface;

FIG. 3 is a graph depicting the composite output of a white light emitting diode in combination with a gold reflector (dotted line) as compared to the prior art white light emitting diode output (solid line); and

FIG. 4 is a cross sectional view depicting a composite light emitting diode and coated reflector assembly in accordance with the teachings of the present invention.

### DETAILED DESCRIPTION OF THE INVENTION

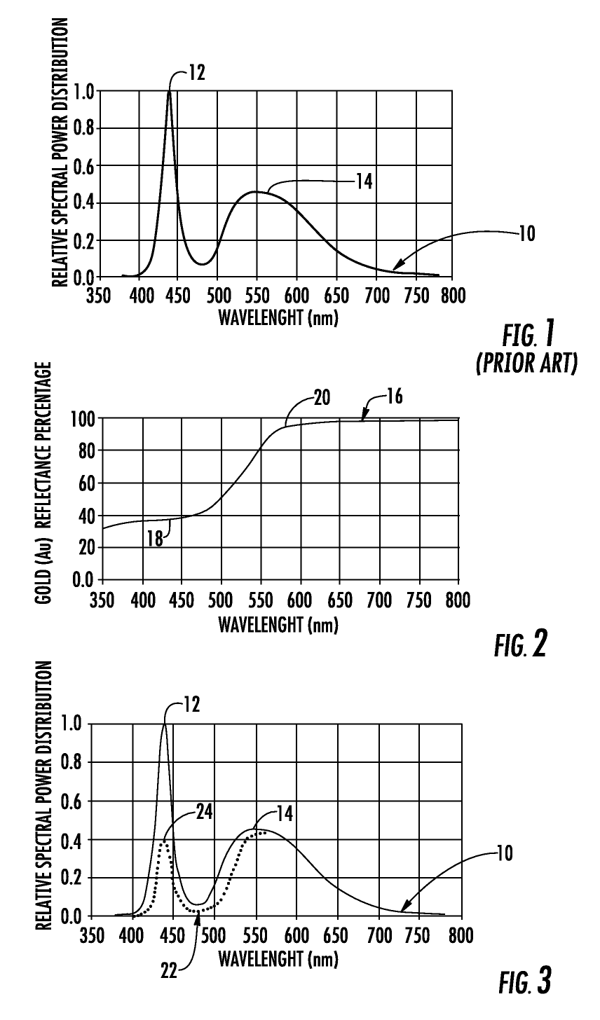

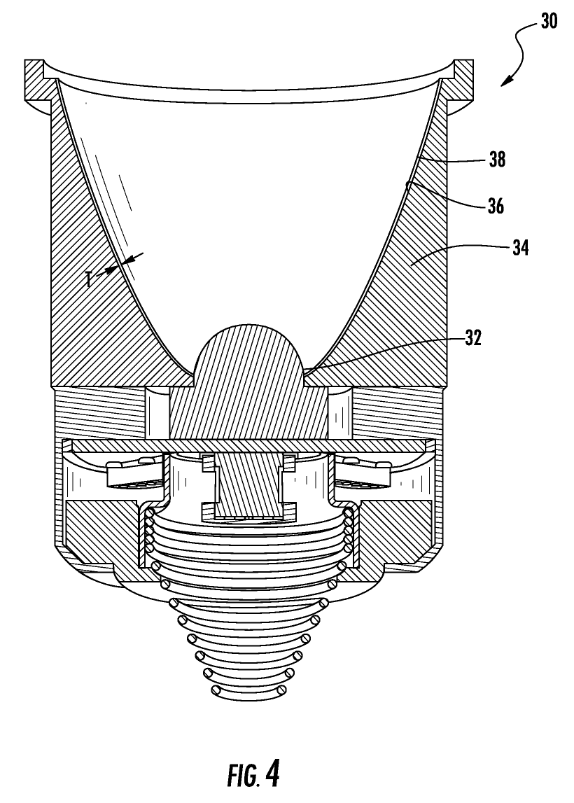

Now referring to the drawings, spectral distribution of a standard white light emitting diode (LED) is depicted at FIG. 1 while the reflective properties associated with an opaque gold reflector is depicted at FIG. 2 and the composite output of a white LED in combination with a gold reflector in accordance with the teachings of the present invention are depicted in FIG. 3. Turning to FIG. 1, the spectral distribution 10 for the output of a white LED clearly can be seen to include a large spike 12 in output at around the 440 nm wavelength range and then can be seen to include a normalized light output distribution 14 around the 500 nm to 650 nm range. Based on a visible light spectrum of between about 400 nm and 700 nm, such an overall spectral output distribution 10 can be appreciated by one skilled in the art to correspond to a light having a bluish cast or having a relatively high color temperature of around 5,500° K. It is also known in the art that a spectral distribution 10 producing a color temperature of around 5,500° K. will produce very poor color rendering. Accordingly, light output having a relatively high color temperature is also referred to as having a poor or a low color rendering index.

Turning to FIG. 2, it can be seen in contrast to the spectral distribution 10 of the LED light output a gold reflector has spectral reflectivity characteristics, as shown by the curve 16 in the graph, of approximately 40% in the blue range 18 of the visible light spectrum (400 nm to around 490 nm) and a reflectivity of greater than 80% for visible light having a wavelength in the green, yellow, orange, red portion of the spectrum 20 starting at around 520 nm and increasing to the upper limits of the visible light spectrum. Accordingly, while the gold reflector reflects approximately 40% of blue light 18 that is incident on the surface it is of note that the remaining 60% of the energy is absorbed by the reflector across this range of relatively short wavelength light output. It is of further note that the gold reflector quickly increases in reflectivity for any relatively long wavelengths 18 of visible light at or above about the 520 nm range. This is a highly advantageous performance characteristic curve 16 when compared to the relative distribution of the wavelength 10 of light output from a typical white LED as is depicted in FIG. 1.

As can be seen in FIG. 3, a combination of a gold reflector with a white LED produces a composite output performance curve 22 illustrated at the dotted line as compared to the output of the LED alone shown at the solid line 10. A reduction in the blue spike 12 or short wavelength energy can be seen at 24 as a result of the gold reflector absorbing approximately 60% of the blue output spike 12 thereby bringing the relative distribution of blue energy back into balance with the normal output range of the other wavelengths in the visible spectrum. This reduction in blue energy in turn causes an upward shift in the average wavelength of the overall light output with a corresponding reduction in the color temperature of the light output ultimately resulting in an improvement in the color rendering index of the light output.

Turning to FIG. 4, the lighting assembly 30 of the present invention preferably includes a conventional white LED 32 and a reflector 34 positioned about the LED 32. As can be appreciated the reflector 34 is formed as is known in the art using spun aluminum, machined aluminum or molded plastic materials. The reflector 34 includes a reflective surface 36 surface is then either highly polished should metallic materials be utilized or has a reflective coating deposited thereon as is the case with plastic materials. The reflective surface 36 surface of the reflector 34 must exhibit optically neutral characteristics, having a silvery mirror like surface. Such neutral properties allows the reflector surface 36 to have a broad reflective range and to reflect nearly all of the light output that falls upon the reflective surface 36. A thin film coating 38 is positioned on top of the reflector surface 36. The thickness “T” of the thin film coating 38 is controlled carefully based on the amount of color shift that is desired. For example, the coating 38 can be applied at varying thickness T that provides for the coating 38 to have a varying density from between at least partially translucent allowing the coating 38 to impart a relatively low gold tone shift in that much of the output light is still reflected by the base reflector surface 36 beneath the thin film coating 38 to a fully opaque coating 38. The density of the coating 38 may fall within the range of about 10% to 100%. As the applied thin film coating 38 gets thicker it becomes less translucent creating a progressively higher gold tone shift. In this manner, increasing the relative gold tone of the output light causes the light to appear warmer, decreasing the color temperature and thereby improving the color-rendering index of the light output from the assembly 30.

It should be appreciated that the desired result that is provided by the present invention it the accomplishment of a spectral shift in a portion of the light output towards longer wavelength warmer tones of light while also maintaining a high level of efficiency. It is this spectral shift in the light output that creates the large improvement in the color-rendering index of the assembly 30. Accordingly, any reflective thin film coating 38 that is applied to the reflective surface 36 of the reflector 34 to achieve such a spectral shift in the light output would still fall within the scope of the present invention. While gold is likely the material that would provide the highest efficiency the present invention is clearly not limited to a gold coating 38.

It can therefore be seen that the present invention provides for a reflector 34 and/or a lighting assembly 30 that includes a reflector 34 adjacent an LED 32 to capture and direct the light output from the LED 32 in a collimated and forward direction. The reflector 34 includes a reflective surface 36 that has a thin film coating 38 thereon that causes a spectral shift in the output the portion of light reflected therefrom causing that portion of the light to become relatively warmer in tone thereby improving the overall color rendering index of the assembly 30. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A reflector for use with a light emitting diode having a light output with a spectral distribution, said reflector comprising:
a reflective surface having a broad spectral range, said reflective surface reflecting nearly all of said light output; and
a coating disposed on said reflective surface, said coating reflecting a first portion of the light output in a first selective portion of said spectral range and absorbing a second portion of the light output in a second selective portion of said spectral range.

2. The reflector of claim 1, wherein said first selective portion of said spectral range is greater than approximately 520 nm and said second selective portion of said spectral range is less than approximately 520 nm.

3. The reflector of claim 1, wherein said first selective portion of said spectral range falls in the relatively long wavelength portion of the visible light spectrum and said second selective portion of said spectral range falls in the relatively short wavelength portion of the visible light spectrum.

4. The reflector of claim 1, wherein said coating causes an average of the spectral distribution of said light output to shift to a longer wavelength.

5. The reflector of claim 4, wherein said coating has a density of between 10% and 100%, wherein a lower density of said coating causes a smaller shift in said light output and a higher density of said coating causes a larger shift in said light output.

6. The reflector of claim 1, wherein said coating causes a color rendering index of said light output to increase.

7. The reflector of claim 1, wherein said coating is translucent.

8. The reflector of claim 1, wherein said coating is opaque.

9. The reflector of claim 1, wherein said coating is a thin layer of gold.

10. A lighting assembly comprising:
a light emitting diode having a light output with a spectral distribution; and
a reflector including:
a reflective surface with a broad spectral range, said reflective surface reflecting nearly all of said light output; and
a coating disposed on said reflective surface, said coating reflecting a first portion of the light output in a first selective portion of said spectral range and absorbing a second portion of the light output in a second selective portion of said spectral range.

11. The lighting assembly of claim 10, wherein said first selective portion of said spectral range is greater than approximately 520 nm and said second selective portion of said spectral range is less than approximately 520 nm.

12. The lighting assembly of claim 10, wherein said first selective portion of said spectral range falls in the relatively long wavelength portion of the visible light spectrum and said second selective portion of said spectral range falls in the relatively short wavelength portion of the visible light spectrum.

13. The lighting assembly of claim 10, wherein said coating causes an average of the spectral distribution of said light output to shift to a longer wavelength.

14. The lighting assembly of claim 13, wherein said coating has a density of between 10% and 100%, wherein a lower density of said coating causes a smaller shift in said light output and a higher density of said coating causes a larger shift in said light output.

15. The lighting assembly of claim 10, wherein said coating causes a color rendering index of said light output to increase.

16. The lighting assembly of claim 10, wherein said coating is translucent.

16. The lighting assembly of claim 10, wherein said coating is opaque.

17. The lighting assembly of claim 10, wherein said coating is a thin layer of gold.

18. A reflector for increasing a color temperature of a light output from a light emitting diode having a first relatively high color temperature, said reflector comprising:
a reflective surface having a neutral reflective surface and reflecting nearly all of said light output; and
a coating disposed on said reflective surface, said coating reflecting a first portion of the light output having a relatively low color temperature and absorbing a second portion of the light output having a relatively high color temperature causing said color temperature of said light output to decrease.

19. The reflector of claim 18, wherein said coating has a density of between 10% and 100%, wherein a lower density of said coating causes a smaller decrease in said color temperature and a higher density of said coating causes a larger decrease in said color temperature.

20. The reflector of claim 18, wherein said coating is a thin layer of gold.
